(19) United States
(12) Patent Application Publication
(10) Pub. No.: US 2016/0342260 A1
(43) Pub. Date: Nov. 24, 2016

(54) SINGLE-LAYER CAPACITIVE TOUCH SCREEN AND TOUCH DISPLAY DEVICE

(71) Applicant: SHENZHEN CHINA STAR OPTOELECTRONICS TECHNOLOGY CO., LTD., Shenzhen, Guangdong (CN)

(72) Inventors: Jiehui QIN, Shenzhen, Guangdong (CN); Jinjie ZHOU, Shenzhen, Guangdong (CN); Xiaoping TAN, Shenzhen, Guangdong (CN)

(73) Assignee: Shenzhen China Star Optoelectronics Technology Co., Ltd., Shenzhen, Guangdong (CN)

(21) Appl. No.: 14/425,041

(22) PCT Filed: Jan. 13, 2015
(86) PCT No.: PCT/CN2015/070602

§ 371 Date: Mar. 1, 2015

(30) Foreign Application Priority Data
Dec. 31, 2014 (CN) 201410854598.0

(51) Int. Cl. G06F 3/041; G02F 1/1333; G06F 3/044

(52) U.S. Cl. CPC G06F 3/0416; G06F 3/0412; G06F 3/044; G02F 1/13338; G06F 2203/04102; G06F 2203/04103; G06F 2203/04104; G06F 2203/04111

(57) ABSTRACT

A single-layer capacitive touch screen is disclosed. The touch screen includes multiple first electrodes arranged along a first direction and multiple second electrodes disposed in a same structure layer with the multiple first electrodes. Wherein, multiple second electrodes are disposed along a second direction which is perpendicular to the first direction, and the multiple second electrodes are respectively corresponding to the first electrodes. Besides, each of the first electrodes includes a main electrode and multiple branch electrodes connected with the main electrode; each of the second electrodes is provided with a concave slot corresponding to a shape of the branch electrode; each branch electrode is embedded into the concave slot of the second electrode; each branch electrode and a corresponding second electrode form a mutual capacitance unit. A touch display device including the single-layer capacitive touch screen is also disclosed.

### BACKGROUND OF THE INVENTION

1. Field of the Invention

The present invention relates to a touch display and more particularly to a single-layer capacitive touch screen and touch display device including the same.

2. Description of Related Art

A touch display screen is as an input medium, which is the most simple and convenient interactive mode between human an machine so that the touch display screen is applied to a variety of electronic products more and more widely. Based on different operation principles and information transmission media, touch screens can be divided into four types: infrared touch screen, capacitive touch screen, resistive touch screen and surface acoustic wave touch screen. Wherein, the capacitive touch screen has advantages of long life, high light transmittance and supporting multi-touch function such that the capacitive touch screen has become the mainstream of the touch screens.

The capacitive touch screen includes a surface capacitive type and a projective capacitive type. Wherein, the projective capacitive type can be divided into a self-capacitive type and a mutual capacitive type. The self-capacitive type fabricates a sensing electrode array and a scanning electrode array on the surface of the glass substrate using indium-tin-oxide (ITO, a transparent and conductive material). The scanning electrode array and the sensing electrode array respectively form a capacitor with a ground. The capacitor is called a self-capacitor, that is, an electrode-to-ground capacitor. When a finger touch a capacitor screen, the capacitor of the finger will add on the capacitor screen such that the quantity of the electric charges of the capacitor screen is increased. When detecting a touch event, the capacitor screen sequentially and respectively detects the sensing electrode array and the scanning electrode array. According to a change of the quantity of the electric charges before and after touching, a coordinate of the sensing electrode array and the scanning electrode array is determined in order to obtain a touch coordinate.

The scanning method of the self-capacitive type touch screen is equal to respectively project a touch point on the touch screen to an X-axis direction and a Y-axis direction, and respectively calculate coordinates at the X-axis direction and the Y-axis direction. Finally, the coordinate of the touch point is obtained. The operation principle of the mutual capacitance type touch screen is shown in FIG. 1. The mutual capacitive type touch screen fabricates a sensing electrode Rx and a scanning electrode Tx on the surface of the glass substrate. The difference between the mutual capacitive type and the self-capacitive type is that at a cross location of the two electrodes, a coupling capacitor C_{M} is formed, that is, the two electrodes respectively form two terminals of the coupling capacitor C_{M}.

When the finger touches the capacitor screen, the coupling effect between two electrodes near the touch point is affected such that the capacitance of the coupling capacitor C_{M} between the two electrodes is changed. When detecting the capacitance of the mutual capacitor, the sensing electrode sends an excitation signal and all of the scanning electrodes receive the signal so as to obtain all capacitance values at cross points of sensing electrodes and scanning electrodes, that is, capacitance values of two dimensional surface of entire touch screen.

According to the data of the capacitance change on the two-dimensional surface of the touch screen, the coordinate of each touch point can be obtained. Therefore, even multiple touch points are existed on the screen, a coordinate of each touch point can be obtained.

However, in the conventional mutual capacitive touch screen, one type of the mutual capacitive touch screen is to fabricate the sensing electrode Rx and the scanning electrode Tx respectively on two ITO conductive layers and disposed on two parallel surfaces. The above type is called double layer ITO mutual capacitive touch screen, called as DITO. The manufacturing process of the touch screen is complex, and the yield rate is limited by the manufacturing process. Another type of the mutual capacitive touch screen is to dispose the sensing electrode Rx and the scanning electrode Tx on the same surface, that is, a single layer ITO mutual capacitive touch screen, also called as SITO. Generally, the sensing electrode array Rx and the scanning electrode array Tx are arranged to be perpendicular to each other. At a cross location of a sensing electrode and a scanning electrode, a bridge method is adopted in order to prevent the sensing electrode and the scanning electrode from contacting with each other. In the single layer ITO mutual capacitive touch screen, a coupling area of a sensing electrode and a scanning electrode is small such that the mutual capacitance is small. When touching, the change of the mutual capacitance is smaller such that the signal-to-noise ratio (SNR) of the touch screen is small.

### SUMMARY OF THE INVENTION

The present invention provides a single-layer capacitive touch screen. The coupling area of the two electrodes of the touch screen is large such that the mutual capacitance is increased so as to increase the signal-to-noise ratio of the touch screen.

In order to achieve the above object, the present invention adopts the following technology solution:

A single-layer capacitive touch screen, comprising: multiple first electrodes arranged along a first direction; and multiple second electrodes disposed in a same structure layer with the multiple first electrodes, wherein, multiple second electrodes are disposed along a second direction which is perpendicular to the first direction, and the multiple second electrodes are respectively corresponding to the first electrodes; wherein, each of the first electrodes includes a main electrode and multiple branch electrodes connected with the main electrode; each of the second electrodes is provided with a concave slot corresponding to a shape of the branch electrode; each branch electrode is embedded into the concave slot of the second electrode; each branch electrode and a corresponding second electrode form a mutual capacitance unit.

Wherein, the branch electrode includes multiple sub-electrodes arranged in parallel and a connection electrode; a terminal of the connection electrode is connected with the main electrode; the other terminal of the connection electrode is respectively connected with the sub-electrodes.

Wherein, each of the sub-electrodes has a symmetric shape using the connection electrode as a symmetric axis.

Wherein, each of the sub-electrodes is a rectangle structure, and the multiple sub-electrodes are parallel with each other.

Wherein, the number of the sub-electrodes is two; the branch electrode formed by the two sub-electrodes and the connection electrode has a structure with “±” shape.

Wherein, each of the sub-electrodes is a diamond shape structure.

Wherein, the number of the sub-electrodes is two.

Wherein, the single-layer capacitive touch screen further includes a flexible circuit board; each of the first electrodes is connected with the flexible circuit board through a first connection line; each of the second electrodes is connected with the flexible circuit board through a second connection line; and wherein, the multiple first electrodes are arranged along the first direction to form multiple column electrodes; the multiple second electrodes which are located in a same horizontal direction, along the first direction and connected with the flexible circuit board through the second connection lines form one row electrode in order to form multiple row electrodes arranged along the second direction.

Wherein, the first electrode, the second electrode, the first connection line, and the second connection line are made of indium tin oxide (ITO).

Another aspect of the present is to provide: a touch display device, comprising: a liquid crystal panel; and a touch screen disposed above the liquid crystal panel, wherein, the touch screen is a single-layer capacitive touch screen, and having: multiple first electrodes arranged along a first direction; and multiple second electrodes disposed in a same structure layer with the multiple first electrodes, wherein, the multiple second electrodes are disposed along a second direction which is perpendicular to the first direction, and the multiple second electrodes are respectively corresponding to the first electrodes; wherein, each of the first electrodes includes a main electrode and multiple branch electrodes connected with the main electrode; each of the second electrodes is provided with a concave slot corresponding to a shape of the branch electrode; each branch electrode is embedded into the concave slot of the second electrode; each branch electrode and a corresponding second electrode form a mutual capacitance unit.

Comparing to the conventional art, in the single-layer capacitive touch screen of the present invention, the branch electrode of the first electrode is embedded into the concave slot of the second electrode such that the branch electrode of the first electrode is surrounded by the second electrode. The capacitance of the mutual capacitance unit formed by the branch electrode and the corresponding second electrode is increased. The signal-to-noise ratio (SNR) of the touch signal of the touch screen is increased.

### BRIEF DESCRIPTION OF THE DRAWINGS

FIG. 1 is a schematic diagram of operation principle for a mutual capacitance touch screen;

FIG. 2 is a schematic diagram of a touch display device according to an embodiment of the present invention;

FIG. 3 is a schematic diagram of a single-layer capacitive touch screen according to an embodiment of the present invention;

FIG. 4 is a schematic diagram of a mutual capacitance unit according to an embodiment of the present invention; and

FIG. 5 is a schematic diagram of a mutual capacitance unit according to another embodiment of the present invention.

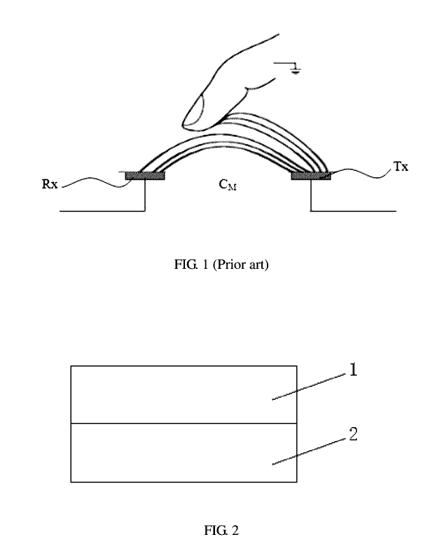

### DETAILED DESCRIPTION OF THE PREFERRED EMBODIMENT

As described above, the object of the invention is to provide a single-layer capacitive touch screen which can increase the signal-to-noise ratio (SNR) of a touch signal of a touch screen. The single-layer capacitive touch screen includes multiple first electrodes and multiple second electrodes disposed in a same structure layer. The first electrodes are arranged along a first direction. Along a second direction which is perpendicular to the first direction, and corresponding to each first electrode, the multiple second electrodes are provided. Wherein, each of the first electrodes includes a main electrode and multiple branch electrodes connected with the main electrode. Each of the second electrodes is provided with a concave slot corresponding to a shape of the branch electrode. Each branch electrode is embedded into the concave slot of the second electrode. Each branch electrode and a corresponding second electrode form a mutual capacitance unit.

Through embedding the branch electrode of the first electrode into the concave slot of the second electrode, the branch electrode of the first electrode is surrounded by the corresponding second electrode such that a capacitance of the mutual capacitance unit formed by the branch electrode and the second electrode is increased in order to increase the SNR of the touch signal of the touch screen.

The following will combine the drawings for further description of the present invention.

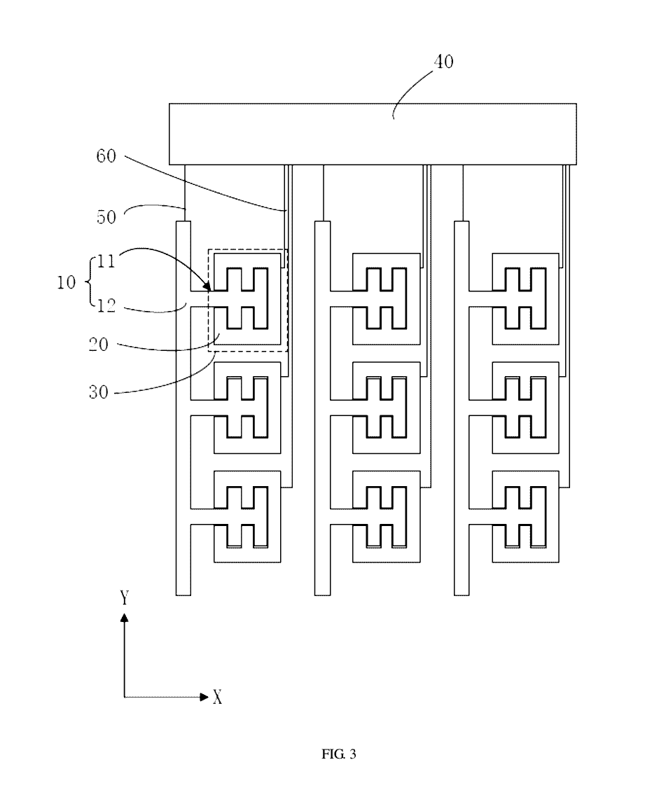

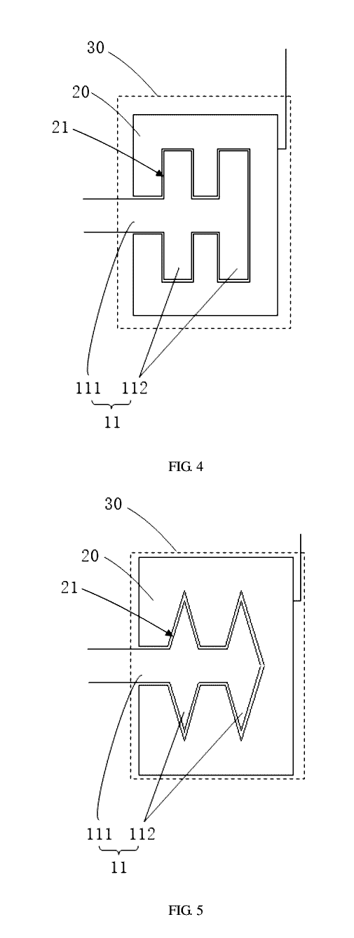

As shown in FIG. 2, the touch display device of the present embodiment includes a liquid crystal panel 2 and a touch screen 1, wherein, the touch screen 1 is a single-layer capacitive touch screen. Through operating the single-layer capacitive touch screen, a user can control the touch display device to display a picture.

Wherein, with reference to FIG. 3 and FIG. 4, the single-layer capacitive touch screen includes multiple first electrodes 10 and multiple second electrodes 20 which are disposed in a same structure layer. The multiple first electrodes 10 are arranged along a first direction (such as the X direction shown in FIG. 3). Along a second direction (such as the Y direction shown in FIG. 3) which is perpendicular to the first direction, and corresponding to each first electrode 10, multiple second electrodes 20 are provided. In the present embodiment shown in FIG. 3, three first electrodes 10 are arranged along the X direction. In the Y direction, corresponding to each first electrode 10, three second electrodes 20 are provided. The single-layer capacitive touch screen further includes a flexible circuit board 40. Each of the first electrodes 10 is connected with the flexible circuit board 40 through a first connection line 50. Each of the second electrodes is connected with the flexible circuit board through a second connection line 60.

Furthermore, in the single-layer capacitive touch screen, the multiple first electrodes 10 are arranged along the first direction (such as the X direction shown in FIG. 3) to form multiple column electrodes. The multiple second electrodes 20 which are located in a same horizontal direction (such as the X direction shown in FIG. 3) and connected with the flexible circuit board 40 through the second connection lines 60 form one row electrode in order to form multiple row electrodes arranged along the second direction (such as the Y direction shown in FIG. 3).

Wherein, the first electrode 10, the second electrode 20, the first connection line 50 and the second connection line 60 are made of indium tin oxide (ITO).

Wherein, as shown in FIG. 4, each of the first electrodes includes a main electrode 12 and three branch electrodes 11 connected with the main electrode 12. The second electrode 20 is provided with a concave slot 21 corresponding to a shape of the branch electrodes 11. Each of the branch electrodes 11 is embedded into the concave slot 21 of one of the second electrodes 20. Each of the branch electrode 11 and a corresponding second electrode 20 form a mutual capacitance unit 30. In the single-layer capacitive touch screen, multiple mutual capacitance units 30 are arranged as an array.

Furthermore, the branch electrode 11 includes multiple sub-electrodes 112 arranged in parallel and a connection electrode 111. A terminal of the connection electrode 111 is connected with the main electrode 12. The other terminal of the connection electrode 111 is respectively connected with the sub-electrodes 112. In a preferred embodiment, each of the sub-electrodes 112 has a symmetric shape using the connection electrode 111 as a symmetric axis.

Specifically, as shown in FIG. 4, each of the sub-electrodes 112 is a rectangle structure, and the number of the sub-electrodes 112 is two. Besides, the two sub-electrodes are parallel with each other. The branch electrode 11 formed by the two sub-electrodes 112 and the connection electrode 111 has a structure with “±” shape.

In another embodiment, each of the sub-electrodes 112 can be a regular shape or an irregular shape. Besides, preferably, the shape of the sub-electrode 112 is a symmetric shape using the connection electrode 111 as a symmetric axis. For example, as shown in FIG. 5, each of the sub-electrodes is a diamond shape structure. The number of the sub-electrodes is two. The branch electrode 11 formed by the two sub-electrodes 112 and the connection electrode 111 has a structure with a sawtooth shape. Each of the second electrodes 20 is provided with a concave slot 21 corresponding to the shape of the branch electrode 11 having the sawtooth shape. The branch electrode 11 having the sawtooth shape is embedded into the concave slot 21. The branch electrode 11 and the second electrode 20 form a mutual capacitance unit 30.

In summary, the embodiment of the present invention provides a single-layer capacitive touch screen. The branch electrode of the first electrode is embedded into the concave slot of the second electrode such that the branch electrode of the first electrode is surrounded by the second electrode. The capacitance of the mutual capacitance unit formed by the branch electrode and the corresponding second electrode is increased. The signal-to-noise ratio (SNR) of the touch signal of the touch screen is increased.

It should be noted that, herein, relational terms such as first and second, and the like are only used to distinguish one entity or operation from another entity or operation. It is not required or implied that these entities or operations exist any such relationship or order between them. Moreover, the terms “comprise,” include,” or any other variation thereof, are intended to cover a non-exclusive inclusion, such that a series of elements including the process, method, article or device that includes not only those elements but also other elements not expressly listed or further comprising such process, method, article or device inherent elements. Without more constraints, by the statement “comprises one . . . ” element defined does not exclude the existence of additional identical elements in the process, method, article, or apparatus.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A single-layer capacitive touch screen, comprising:
multiple first electrodes arranged along a first direction; and
multiple second electrodes disposed in a same structure layer with the multiple first electrodes, wherein, multiple second electrodes are disposed along a second direction which is perpendicular to the first direction, and the multiple second electrodes are respectively corresponding to the first electrodes;
wherein, each of the first electrodes includes a main electrode and multiple branch electrodes connected with the main electrode; each of the second electrodes is provided with a concave slot corresponding to a shape of the branch electrode; each branch electrode is embedded into the concave slot of the second electrode; each branch electrode and a corresponding second electrode form a mutual capacitance unit.

2. The single-layer capacitive touch screen according to claim 1, wherein, the branch electrode includes multiple sub-electrodes arranged in parallel and a connection electrode; a terminal of the connection electrode is connected with the main electrode; the other terminal of the connection electrode is respectively connected with the sub-electrodes.

3. The single-layer capacitive touch screen according to claim 2, wherein, each of the sub-electrodes has a symmetric shape using the connection electrode as a symmetric axis.

4. The single-layer capacitive touch screen according to claim 3, wherein, each of the sub-electrodes is a rectangle structure, and the multiple sub-electrodes are parallel with each other.

5. The single-layer capacitive touch screen according to claim 4, wherein, the number of the sub-electrodes is two; the branch electrode formed by the two sub-electrodes and the connection electrode has a structure with “+” shape.

6. The single-layer capacitive touch screen according to claim 3, wherein, each of the sub-electrodes is a diamond shape structure.

7. The single-layer capacitive touch screen according to claim 4, wherein, the number of the sub-electrodes is two.

8. The single-layer capacitive touch screen according to claim 1, wherein, the single-layer capacitive touch screen further includes a flexible circuit board; each of the first electrodes is connected with the flexible circuit board through a first connection line; each of the second electrodes is connected with the flexible circuit board through a second connection line; and
wherein, the multiple first electrodes are arranged along the first direction to form multiple column electrodes; the multiple second electrodes which are located in a same horizontal direction, along the first direction and connected with the flexible circuit board through the second connection lines form one row electrode in order to form multiple row electrodes arranged along the second direction.

9. The single-layer capacitive touch screen according to claim 8, wherein, the first electrode, the second electrode, the first connection line, and the second connection line are made of indium tin oxide (ITO).

10. A touch display device, comprising:
a liquid crystal panel; and
a touch screen disposed above the liquid crystal panel, wherein, the touch screen is a single-layer capacitive touch screen, and having:
multiple first electrodes arranged along a first direction; and
multiple second electrodes disposed in a same structure layer with the multiple first electrodes, wherein, the multiple second electrodes are disposed along a second direction which is perpendicular to the first direction, and the multiple second electrodes are respectively corresponding to the first electrodes;
wherein, each of the first electrodes includes a main electrode and multiple branch electrodes connected with the main electrode; each of the second electrodes is provided with a concave slot corresponding to a shape of the branch electrode; each branch electrode is embedded into the concave slot of the second electrode; each branch electrode and a corresponding second electrode form a mutual capacitance unit.

11. The touch display device according to claim 10, wherein, the branch electrode includes multiple sub-electrodes arranged in parallel and a connection electrode; a terminal of the connection electrode is connected with the main electrode; the other terminal of the connection electrode is respectively connected with the sub-electrodes.

12. The touch display device according to claim 11, wherein, each of the sub-electrodes has a symmetric shape using the connection electrode as a symmetric axis.

13. The touch display device according to claim 12, wherein, each of the sub-electrodes is a rectangle structure, and the multiple sub-electrodes are parallel with each other.

14. The touch display device according to claim 13, wherein, the number of the sub-electrodes is two; the branch electrode formed by the two sub-electrodes and the connection electrode has a structure with “+” shape.

15. The touch display device according to claim 12, wherein, each of the sub-electrodes is a diamond shape structure.

16. The touch display device according to claim 15, wherein, the number of the sub-electrodes is two.

17. The touch display device according to claim 10, wherein, the single-layer capacitive touch screen further includes a flexible circuit board; each of the first electrodes is connected with the flexible circuit board through a first connection line; each of the second electrodes is connected with the flexible circuit board through a second connection line; and
wherein, the multiple first electrodes are arranged along the first direction to form multiple column electrodes; the multiple second electrodes which are located in a same horizontal direction, along the first direction and connected with the flexible circuit board through the second connection lines form one row electrode in order to form multiple row electrodes arranged along the second direction.

18. The touch display device according to claim 17, wherein, the first electrode, the second electrode, the first connection line, and the second connection line are made of indium tin oxide (ITO).
